(19) United States
(12) Patent Application Publication
(10) Pub. No.: US 2014/0283993 A1
(43) Pub. Date: Sep. 25, 2014

(54) ETCHING APPARATUS

(71) Applicant: Samsung Display Co., Ltd., Yongin-City (KR)

(72) Inventors: Yun-Sik Ham, Yongin-City (KR); Jae-Kwang Jeon, Yongin-City (KR)

(21) Appl. No.: 14/219,640

(22) Filed: Mar. 19, 2014

(30) Foreign Application Priority Data
Mar. 22, 2013 (KR) 10-2013-0031019

(51) Int. Cl. B05B 9/03

(52) U.S. Cl. CPC B05B 9/03
USPC 156/345.18; 156/345.21

(57) ABSTRACT

A shower-type etching apparatus that includes a support member supporting a substrate in an inclined manner, a first spray member arranged at a lower end of the inclined substrate spraying a smaller amount of etching solution onto the substrate than a second spray member arranged at an upper end of the inclined substrate by increasing a pitch distance between adjacent nozzles in the first spray member as compared to the second spray member.

### CLAIM OF PRIORITY

This application makes reference to, incorporates the same herein, and claims all benefits accruing under 35 U.S.C. §119 from an application earlier filed in the Korean Intellectual Property Office filed on 22 Mar. 2013 and there duly assigned Serial No. 10-2013-0031019.

### BACKGROUND OF THE INVENTION

1. Field of the Invention

The described technology relates generally to a wet etching apparatus that provides a more uniform etch uniformity.

2. Description of the Related Art

An etching method has been widely used in manufacturing of a flat panel display panel and a semiconductor. The etching method may include, for example, dip etching and shower etching. When dip etching is used, a substrate is dipped in an etching solution for etching, and when shower etching is used, the etching solution is sprayed onto the substrate for etching.

The dip etching method has drawbacks in that thickness uniformity is low over the entire area of the substrate, etch rate deterioration speed is high, a large etching solution bath is required so that the etching solution bath is difficult to manage, and it is difficult to remove sludge generated during an etching process.

On the other hand, the shower etching method has problems in that over etching may occur or the substrate may be stained when the etching solution is not uniformly sprayed. In particular, after spraying of the etching solution, a time during which the substrate contacts the etching solution and the size of an area of the substrate contacting the etching solution may vary depending on a location and on a path through which the etching solution applied, so that the substrate may include a portion that is not properly etched.

The above information disclosed in this Background section is only for enhancement of understanding of the background of the described technology and therefore it may contain information that does not form the prior art as per 35 U.S.C. §102.

### SUMMARY OF THE INVENTION

The described technology has been made in an effort to provide an etching apparatus that can perform uniform etching via a shower etching technique.

According to one aspect of the present invention, there is provided an etching apparatus that includes a support member supporting a substrate in an inclined manner, a first spray member spraying a first amount of etching solution onto the substrate and a second spray member spraying a second and larger amount of etching solution onto the substrate, wherein the first spray member is arranged near a lower end of the substrate and the second spray member is arranged near an upper end of the substrate. Each of the first and second spray members may include a transfer pipe extending in a first direction and a plurality of nozzles arranged on the transfer pipe. A number of nozzles arranged on the second spray member may be greater than a number of nozzles arranged on the first spray member. The number of nozzles arranged on the second spray member may be 1.2 to 3 times the number of nozzles arranged on the first spray member. An outlet diameter of each nozzle arranged on the second spray member may be larger than an outlet diameter of each nozzle arranged on the first spray member. An outlet diameter of each nozzle arranged on the second spray member may be 1.1 to 3 times an outlet diameter of each nozzle arranged on the first spray member.

The etching apparatus may also include a distribution pipe connected and to supply an etching solution to each of the first and second spray members. The etching apparatus may also include a plurality of first spray members and a plurality of second spray members, the distribution pipe may be connected to the plurality of second spray members, the plurality of second spray members may be arranged closer to the upper end of the substrate than the plurality of first spray members. The etching apparatus may also include a third spray member arranged between the second spray member and the first spray member to spray a smaller amount of etching solution onto the substrate than the second spray member and to spray a greater amount of etching solution onto the substrate than the first spray member. The third spray member may include fewer nozzles than the second spray member and more nozzles than first spray member. The etching apparatus may also include a fourth spray member to spray a smaller amount of etching solution onto the substrate than the third spray member; and a fifth spray member to spray a smaller amount of etching solution onto the substrate than the fourth spray member, the fifth spray member may spray a larger amount of etching solution onto the substrate than the first spray member, the fourth spray member may be arranged between the third spray member and the fifth spray member, and the fifth spray member may be arranged between the fourth spray member and the first spray member.

According to another aspect of the present invention, there is provided a spray etching apparatus that includes a support member arranged on a lower side of the substrate to support the substrate at an incline and a plurality of spray members arranged over an upper side of the substrate and extending in a first direction across the substrate and being spaced-apart from one another from a lower end to an upper end of the inclined substrate, one of the spray members arranged closest to the upper end of the inclined substrate may discharge an etching solution at a greater rate than one of the spray members arranged closest to the lower end of the inclined substrate. A discharge rate of etching solution of the spray members may get progressively larger in moving from the lower end to the upper end of the substrate. The discharge rate of each spray member varies according to a spacing between adjoining nozzles on any given spray member. The discharge rate of each spray member varies according to an inner diameter of nozzles arranged on any given spray member.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of an etching apparatus according to a first exemplary embodiment;

FIG. 2 is a side view of the etching apparatus according to the first exemplary embodiment;

FIG. 3A is a photo illustrating a substrate etched using an earlier etching apparatus;

FIG. 3B is a photo illustrating a substrate etched using the etching apparatus according to the first exemplary embodiment;

FIG. 4A is a graph showing critical dimensions of the substrate etched using the earlier etching apparatus;

FIG. 4B is a graph showing critical dimensions of the substrate etched using the etching apparatus according to the first exemplary embodiment;

FIG. 5 is a perspective view of an etching apparatus according to a second exemplary embodiment;

FIG. 6 is a perspective view of an etching apparatus according to a third exemplary embodiment;

FIG. 7 is a perspective view of an etching apparatus according to a fourth exemplary embodiment;

FIG. 8A is a cross-sectional view of a first nozzle according to a fourth exemplary embodiment; and

FIG. 8B is a cross-sectional view of a second nozzle according to the fourth exemplary embodiment.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In addition, unless explicitly described to the contrary, the word “comprise” and variations such as “comprises” or “comprising”, will be understood to imply the inclusion of stated elements but not the exclusion of any other elements. Further, it will be understood that the word “on”, “over”, or “above” refers to being over or below a subject member, and does not necessarily refer to being over the subject member on the basis of the direction of gravity.

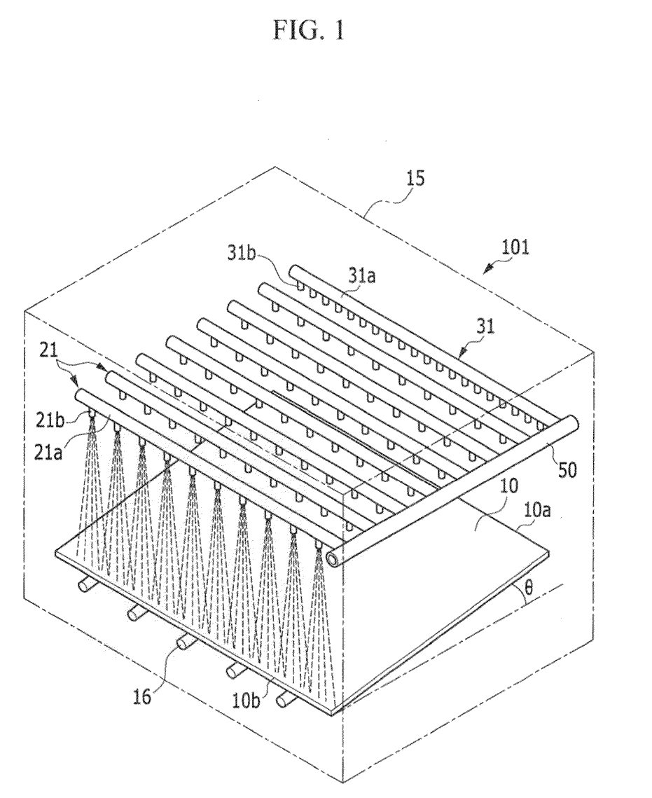

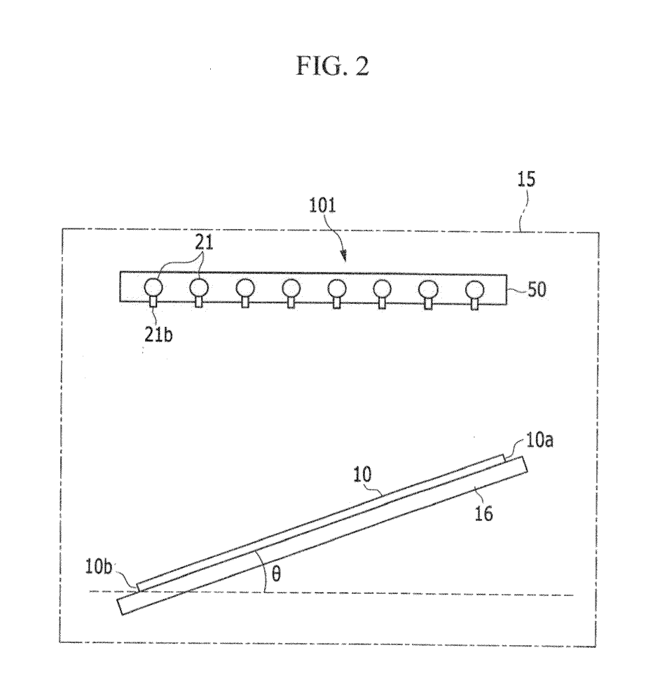

Turning now to FIGS. 1 and 2, FIG. 1 is a schematic diagram of an etching apparatus according to a first exemplary embodiment, and FIG. 2 is a side view of the etching apparatus according to the first exemplary embodiment. Referring to FIG. 1 and FIG. 2, an etching apparatus 101 according to the first exemplary embodiment includes a plurality of first spray members 21 and a second spray member 30 spraying an etching solution onto a substrate 10 and a support member 16 supporting the substrate 10.

The substrate 10 may be a substrate that can be applied to a flat-type display, such as an organic light emitting diode (OLED) display, a liquid crystal display, and the like, and various types of substrates such as a semiconductor wafer are applicable. The substrate 10 may have various shapes such as a square, a circle, and the like.

The substrate 10, the support member 16, and the spray members 21 and 31 are provided in a chamber 15, and the chamber 15 is substantially formed in the shape of a quadrangle. In addition, the chamber 15 includes an opening for ingress and egress of substrate 10.

The support member 16 supports and transfers the substrate 10, and supports the substrate 10 in an inclined manner such that one side end of the substrate 10 is disposed lower than the other side end thereof. The substrate 10 has an inclination angle θ with respect to the ground such that a lower side end 10b of the substrate 10 is disposed lower than an upper side end 10a thereof. As described, when the substrate 10 is inclined, discharge of an etching solution can be simply controlled to thereby prevent a part of the substrate 10 from being excessive etched. That is, when the substrate 10 is disposed in parallel to the ground, the etching solution stagnates in a part of the substrate 10, thereby causing excessive etching of the portion, and the excessive etching may generate inaccurate and/or non-uniform patterns.

The support member 16 is formed in the shape of a cylindrical bar, and a plurality of rollers may be provided on the support member 16. Since a plurality of support members 16 are provided under the substrate 10 to transfer the substrate 10, the substrate 10 may be moved within the chamber 15 or removed from the chamber 15 according to rotation of the support members 16.

Each first spray member 21 includes a first transfer pipe 21a extending in a first direction and a plurality of nozzles 21b provided on the transfer pipe 21a. The transfer pipe 21a is formed in the shape of a cylindrical pipe, and the plurality of nozzles 21b are spaced-apart from one another by a first distance in a lower portion of the transfer pipe 21a. An etching solution is sprayed onto the substrate 10 through the nozzles 21b, and the sprayed etching solution etches the exposed substrate 10 to form a pattern. The etching apparatus 101 includes a plurality of first spray members 21, and the first spray members 21 are arranged starting from the lower side end 10b of the substrate 10.

The second spray member 31 includes a transfer pipe 31a extending in the first direction and a plurality of nozzles 31b provided on the transfer pipe 31a. The transfer pipe 31a is formed in the shape of a cylindrical pipe, and a plurality of nozzles 31b are spaced-apart from one another by a second and shorter distance at a lower portion of the transfer pipe 31a. The etching solution is sprayed onto the substrate 10 through the nozzles 31b, and the sprayed etching solution etches the exposed substrate 10 to form a pattern. The etching apparatus 101 of the first embodiment includes a single second spray member 31, and the second spray 31 is disposed at the upper side end 10a of the substrate 10.

Each first spray member 21 and the second spray member 31 are connected to a distribution pipe 50 supplying the etching solution to the first and second spray members 21 and 31, and the distribution pipe 50 is connected to the plurality of first spray members 21 and the second spray member 31 to supply the etching solution to the respective spray members 21 and 31.

The second spray member 31 sprays a larger amount of etching solution onto the substrate 10 than each first spray member 21 by spraying the etching solution at a higher rate than the each first spray member. In order to accomplish this, the number of nozzles 31b provided on the second spray member 31 is greater than the number of nozzles provided on each of the first spray members 21. By making the second distance shorter than the first distance, the number of nozzles 31b provided on the second spray member 31 may be 1.2 to 3 times the number of nozzles 21b provided on each of the first spray members 21. A ratio of the number of the nozzles 31b provided on the second spray member 31 to the number of nozzles 21b provided on each first spray member 21 may be vary depending on the application for etching, which may depend upon the size of the substrate 10 and the inclination angle of the substrate 10.

When the number of nozzles 31b provided on the second spray member 31 is less than 1.2 times the number of nozzles 21b provided on each first spray member 21, the upper portion of the substrate cannot be appropriately etched, and when the number of nozzles 31b provided on the second spray member 31 is more than 3 times the number of nozzles 21b provided on each first spray member 21, an excessive amount of etching solution is sprayed, thereby causing over etching.

As described above, according to the first exemplary embodiment, when the substrate 10 is in the inclined state, the upper side end 10a of the substrate 10 can be properly etched by supplying more etching solution to the upper side end 10a of the substrate 10. This is because when the substrate 10 is inclined, the etching solution supplied to the upper side end 10a of the substrate 10 moves down to the lower side end 10b of the substrate 10 due to gravity, so that the lower side end 10b of the substrate 10 contacts the etching solution relatively longer than the upper side end of the substrate 10. Accordingly, there is a tendency to under etch the upper side end 10a of the substrate 10 as compared to the lower side end 10b of the substrate 10. However, according to the first exemplary embodiment, this non uniformity in etching between upper and lower side ends of an inclined substrate is compensated for by supplying a greater amount of etching solution to the upper side end 10a of the substrate 10 than to the lower side end 10b of the substrate 10, so that the substrate 10 can be uniformly etched even through the substrate 10 is inclined.

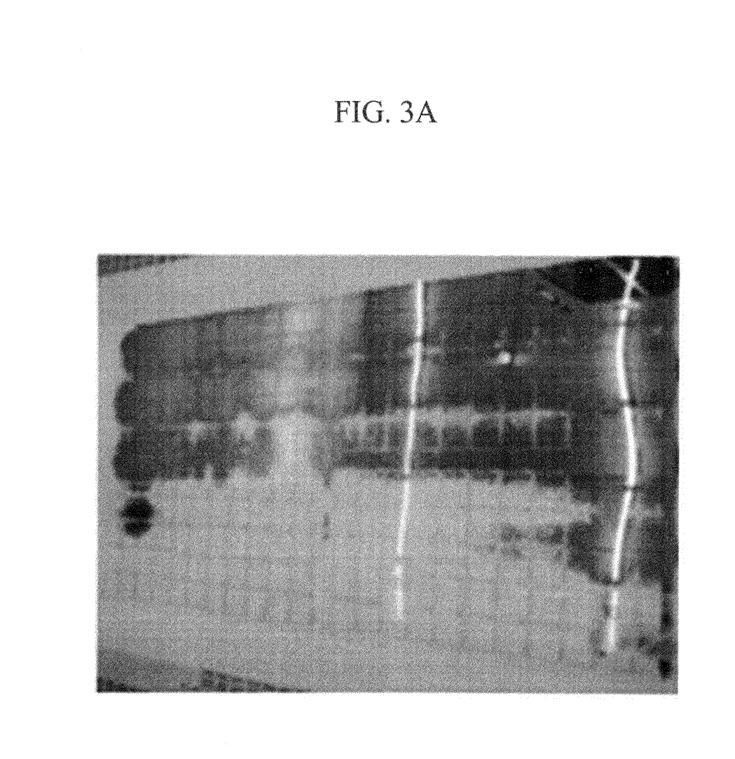

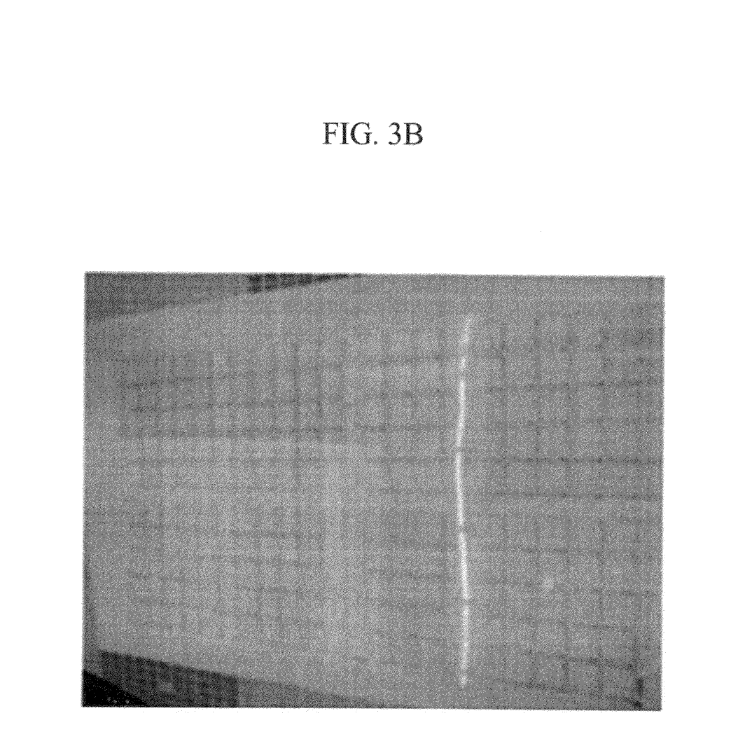

Turning now to FIGS. 3A and 3B, FIG. 3A is a photo illustrating a substrate etched using an earlier etching apparatus and FIG. 3B is a photo illustrating a substrate etched using the etching apparatus according to the first exemplary embodiment of the present invention. As shown in FIG. 3A, in an earlier etching apparatus, an amount and a rate of etching solution applied to the lower portion of a substrate is the same as that applied to the upper portion of the substrate. Because the substrate is inclined, the etching solution applied to the upper portion of the substrate quickly runs off and concentrates at the lower portion of the substrate, so that the upper portion is etched less than the lower portion of the substrate. However, as shown in FIG. 3B, according to the first exemplary embodiment of the present invention, the upper portion and the lower portion of the substrate can be uniformly etched even though the substrate is inclined at an angle by applying more etchant to the upper portion than to the lower portion of the substrate.

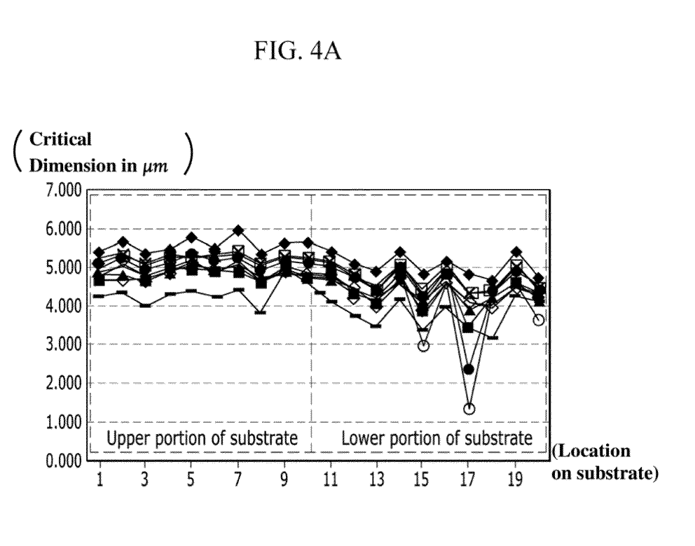

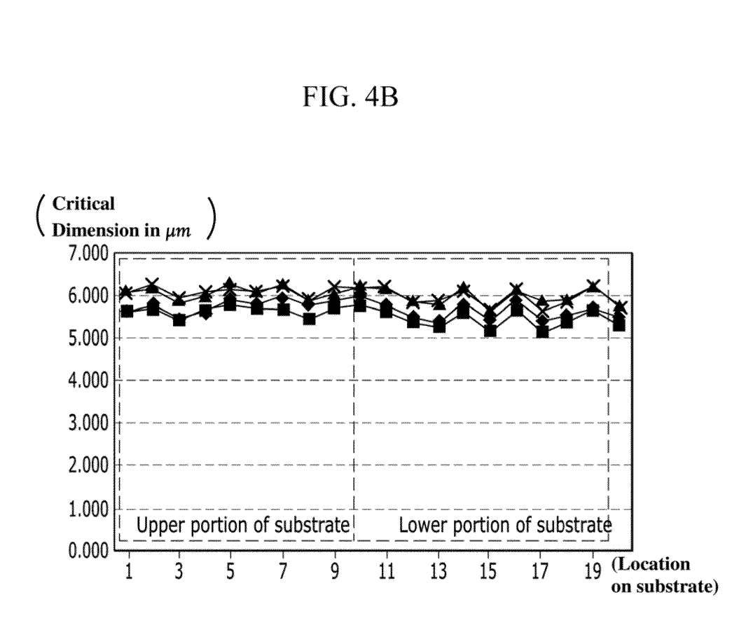

Turning now to FIGS. 4A and 4B. FIG. 4A is a graph showing critical dimensions of the substrate etched using the earlier etching apparatus and FIG. 4B is a graph showing critical dimensions of the substrate etched using the etching apparatus according to the first exemplary embodiment of the present invention. As shown in FIG. 4A, when a time period for etching is extending to properly etch the upper portion of the substrate, the critical dimensions of the lower portion of the substrate is decreased. However, as shown in FIG. 4B, according to the present exemplary embodiment, the upper portion of the substrate and the lower portion of the substrate have uniform critical dimensions.

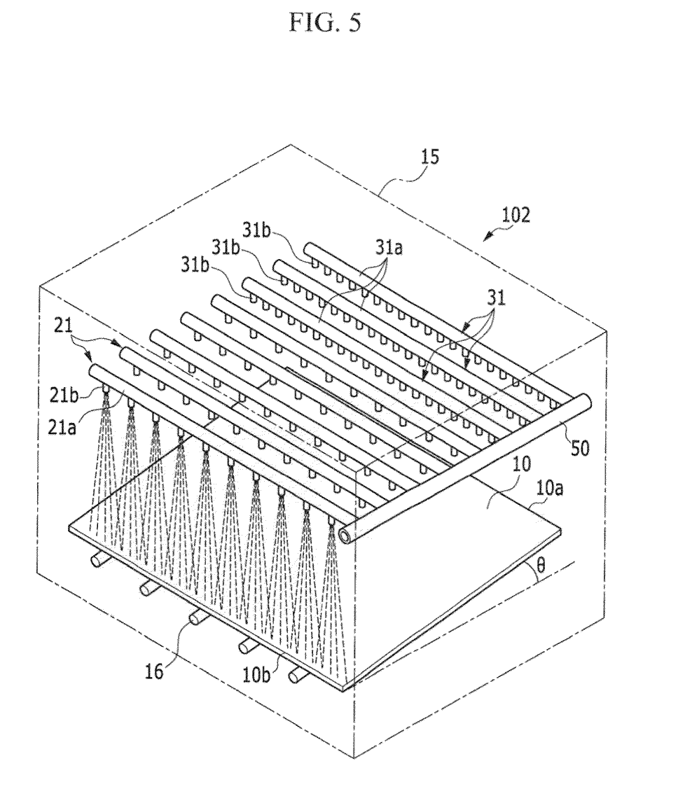

Turning now to FIG. 5, FIG. 5 is a perspective view of an etching apparatus according to a second exemplary embodiment. Referring to FIG. 5, an etching apparatus 102 according to the second exemplary embodiment includes first and second spray members 21 and 31 spraying an etching solution onto a substrate 10 and a support member 16 supporting the substrate 10. The etching apparatus 102 according to the second exemplary embodiment is the same as the etching apparatus of the first exemplary embodiment, with the exception of the number of the second spray members 31, and therefore a description of like features will be omitted.

A plurality of first etching members 21 are provided within the etching apparatus 102, and each of the first spray members 21 includes a transfer pipe 21a extending in a first direction and a plurality of nozzles 21b formed on the transfer pipe 21a. In addition, a plurality of second spray members 31 are also included, and each of the second spray members 31 also includes a transfer pipe 31a extending in the first direction and a plurality of nozzles 31b formed on the transfer pipe 31a. A distribution pipe 50 is connected to each first spray member 21 and each second spray member 31, and the distribution pipe 50 supplies the etching solution to the respective spray members 21 and 31.

In the second embodiment, the etching apparatus 102 includes three second spray members 31, however the present invention is not limited thereto as the etching apparatus 102 may include any number of second spray members 31. Furthermore, the number of second spray members 31 may be vary depending on the size of the substrate 10, a material of the substrate 10, an etching condition, inclination angle, and an etching time.

The number of nozzles 31b formed in each of the second spray members 31 is greater than the number of nozzles 21b formed in each of the first spray members 21, and accordingly, each of the second spray members 31 discharge etchant at a higher rate than do each of the first spray members 21, and thus each second spray member 31 sprays a larger amount of etching solution onto the substrate 10 than each of the first spray members 21. In addition, the second spray members 31 are disposed towards an upper side end 10a of the substrate 10 while the first spray members 21 are arranged near a lower side end 10b of the substrate 10.

As described above, according to the second exemplary embodiment, a larger amount of etching solution is sprayed onto the upper portion 10a of the inclined substrate 10 to provide a uniform etch throughout the entire substrate 10. When the area of the substrate 10 is very large or the substrate 10 has a large inclination angle, the upper portion of the substrate 10 cannot be uniformly etched only using one second spray member. Therefore, the etching apparatus 102 according to the second embodiment provides a plurality of second spray members 31 in consideration of the size of the substrate 10 and etching conditions, such as an inclination angle and the like, to thereby provide a uniform etch throughout the entire substrate 10.

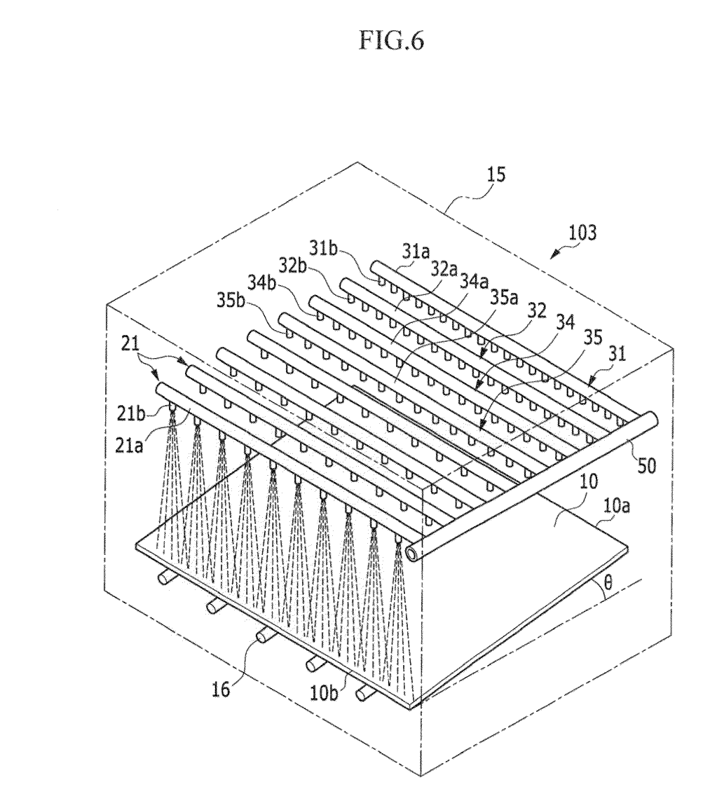

Turning now to FIG. 6, FIG. 6 is a perspective view of an etching apparatus according to a third exemplary embodiment. Referring now to FIG. 6, an etching apparatus 103 according to the third exemplary embodiment includes a plurality of first spray member 21, a second spray member 31, a third spray member 32, a fourth spray member 34, a fifth spray member 35, and a support member 16 supporting a substrate 10. The first, second, third, fourth, and fifth spray members 21, 31, 32, 34, 35 spray an etching solution onto the substrate 10.

The etching apparatus 103 according to the third exemplary embodiment is the same as the etching apparatus of the first exemplary embodiment, with the exception of the third, fourth, and fifth spray members 32, 34, and 35, and therefore a description of like features will be omitted.

A plurality of first etching members 21 are provided on the etching apparatus 103, and each of the first spray members 21 includes a transfer pipe 21a extending in the first direction and a plurality of nozzles 21b formed on the transfer pipe 21a.

The second spray member 31 includes a transfer pipe 31a extending in the first direction and a plurality of nozzles 31b provided on the transfer pipe 31a, the third spray member 32 includes a transfer pipe 32a extending in the first direction and a plurality of nozzles 32b provided on the transfer pipe 32a, the fourth spray member 34 includes a transfer pipe 34a extending in first direction and a plurality of nozzles 34b provided on the transfer pipe 34a and the fifth spray member 35 includes a transfer pipe 35a extending in the first direction and a plurality of nozzles 35b provided on the transfer pipe 35a.

In addition, the first spray members 21, the second spray member 31, the third spray member 32, the fourth spray member 34, and the fifth spray member 35 are connected to a distribution pipe 50 that supplies an etching solution to the respective spray members 21, 31, 32, 34, and 35.

The third spray member 32 sprays the etching solution onto the substrate 10 at a slower rate than the second spray member 31, and sprays etching solution at a higher rate than the fourth spray member 34. In addition, the fourth spray member 34 sprays etching solution at a lower rate than the third spray member 32 and at a higher rate than the fifth spray member 35, and the fifth spray member 35 sprays at a lower rate than the fourth spray member 34 and sprays at a higher rate than the first spray members 21. Consequently, the discharge rate of etching solution and the amount discharged onto substrate 10 progressively increases in going from the lower side end 10b to the upper side end 10a in the third embodiment. In other words, the discharge rate of etching solution and the amount discharged onto substrate 10 progressively increases in going from the first spray member 21 to the fifth spray member 35 to the fourth spray member 34 to the third spray member 32 and to the second spray member 31.

In order to achieve this, the number of nozzles 32b provided on the third spray member 32 is less than the number of nozzles 31b provided on the second spray member 31, and is greater than the number of nozzles 34b provided on the fourth spray member 34. In addition, the number of nozzles 34b provided on the fourth spray member 34 is less than the number of nozzles 32b provided on the third spray member 32, and is greater than the number of nozzles 35b provided on the fifth spray member 35. Further, the number of nozzles 35b of the fifth spray member 35 is less than the number of nozzles 34b of the fourth spray member 34, and is greater than the number of nozzles 21b provided on each of the first spray members 21.

That is, as shown in FIG. 6, when each first spray member 21 includes, for example, 10 nozzles 21b, the second spray member 31 may include 20 nozzles 31b, the third spray member 32 may include 18 nozzles 32b, the fourth spray member 34 may include 16 nozzles 34b, and the fifth spray member 35 may include 14 nozzles 35b. In addition, the third spray member 32 is disposed between the second spray member 31 and the fourth spray member 34, the fourth spray member 34 is disposed between the third spray member 32 and the fifth spray member 35, and the fifth spray member 35 is disposed between the fourth spray member 34 and the first spray member 21.

Accordingly, the number of nozzles per spray member progressively decreases in moving towards the lower side end 10b of the substrate 10 from the upper side end 10a of the substrate 10, and the number of nozzles per spray member for a spray member disposed near the lower side end 10b of the substrate 10 is less than the number of nozzles per the spray member for a spray member disposed near the upper side end 10a of the substrate 10.

As described, the amount of sprayed etching solution per spray member progressively decreases towards the lower side end 10b of the substrate 10 from the upper side end 10a of the substrate 10 according to the third exemplary embodiment, so that the upper side end 10a of the substrate 10 can be further effectively etched, thereby uniformly etching the entire substrate 10.

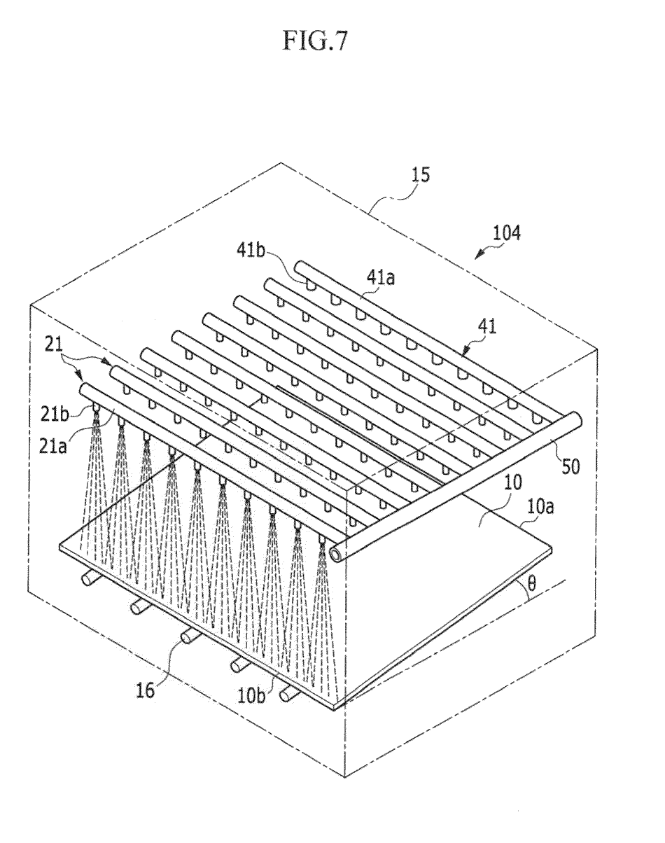

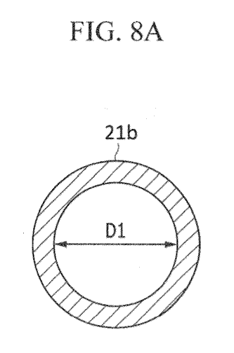

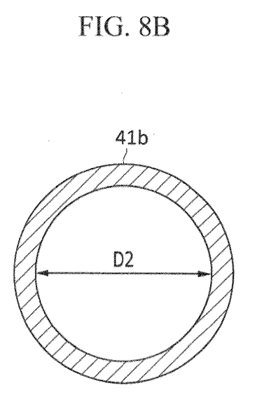

Turning now to FIGS. 7, 8A and 8B, FIG. 7 is a perspective view of an etching apparatus according to a fourth exemplary embodiment, FIG. 8A is a cross-sectional view of a first nozzle according to the fourth exemplary embodiment, and FIG. 8B is a cross-sectional view of a second nozzle according to the fourth exemplary embodiment.

Referring to FIG. 7, FIG. 8A, and FIG. 8B, an etching apparatus 104 according to the fourth exemplary embodiment includes first and second spray members 21 and 41 spraying an etching solution to a substrate 10 and a support member 16 supporting the substrate 10. The etching apparatus 104 according to the fourth exemplary embodiment is the same as the etching apparatus of the first exemplary embodiment, with the exception of the structure of the second spray member 41, and therefore a repeated description of same features will be omitted.

The etching apparatus 104 includes a plurality of first spray members 21, and each of the first spray members 21 includes a transfer pipe 21a extending in the first direction and a plurality of nozzles 21b provided on the transfer pipe 21a. In addition, the second spray member 41 includes a transfer pipe 41a extending in the first direction and a plurality of nozzles 41b provided on the transfer pipe 41a. The first spray members 21 and the second spray member 41 are connected to a distribution pipe 50 supplying an etching solution to the respective spray members 21 and 41, and the distribution pipe 50 supplies the etching solution to the first and second spray members 21 and 41.

In the fourth embodiment, an outlet diameter D2 of each nozzle 41b provided on the second spray member 41 is larger than an outlet diameter D1 of each nozzle 21b provide in the first spray member 21. Here, the outlet diameter implies an interior diameter of a lower end of the nozzle.

The outlet diameter D2 of the nozzle 41b provided on the second spray member 41 is 1.1 to 3 times the outlet diameter D1 of the nozzle 21b provided on the first spray member 21.

When the outlet diameter D2 of the nozzle 41b provided on the second spray member 41 is less than 1.1 times the outlet diameter D1 of the nozzle 21b of the first spray member 21, the upper portion of the substrate 10 cannot be properly etched, and when the outlet diameter D2 of the nozzle 41b provided on the second spray member 41 is larger than 3 times the outlet diameter D1 of the nozzle 21b provided on the first spray member 21, an excessive amount of spray solution is sprayed so that the substrate 10 may be excessively etched.

The fourth embodiment is not limited specifically to the arrangement in FIG. 7, as various modifications can be made and still be within the scope of the present invention. For example, the inner diameter of nozzles on each transfer pipe can get progressively smaller in moving from the upper side end 10a to the lower side end 10b of substrate 10 to provide a progressively reducing rate of discharge of etching solution from each spray member in moving from the upper side end 10a to the lower side end 10b, and still be within the scope of the present invention. Alternately, a combination of the fourth embodiment and one of the first through third embodiments can be implemented, whereby a discharge rate and a discharge quantity of etching solution from a spray member is achieved by a combination of increasing a number of nozzles per transfer pipe and an increasing an inner diameter of each nozzle, and still be within the scope of the present invention.

According to the present invention, a spray etching apparatus is provided that achieves a more uniform etch of an inclined large substrate by varying a discharge rate of etching solution applied to different portions of the inclined substrate in order to compensate for uneven etch characteristics. This variation in discharge rate can be achieved by merely modifying a spray member closest to the upper side end of substrate 10 to include either more nozzles and/or increasing an inner diameter of each nozzle as compared to other spray members further from the upper side end 10a of an inclined substrate. Alternatively, a variation of discharge rate can instead be achieved by progressively increasing the rate of discharge and the amount discharge of etchant of spray members in going from a lower side end 10b to an upper side end 10a of an inclined substrate by either including more nozzles per spray member and/or increasing a diameter of the nozzles. By doing so, variations in etch amounts of an inclined substrate 10 can be compensated for, resulting in a uniform etch throughout the substrate by a spray process.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

101, 102, 103, 104: etching apparatus

10: substrate

10a: upper side end

10b: lower side end

15: chamber

16: support member

21: first spray member

21a, 31a, 32a, 34a, 35a, 41a: transfer pipe

21b, 31b, 32b, 34b, 35b, 41b: nozzle

31, 41: second spray member

32: third spray member

34: fourth spray member

35: fifth spray member

50: distribution pipe

What is claimed is:

1. An etching apparatus, comprising:
a support member supporting a substrate in an inclined manner;
a first spray member spraying a first amount of etching solution onto the substrate; and
a second spray member spraying a second and larger amount of etching solution onto the substrate, wherein the first spray member is arranged near a lower end of the substrate and the second spray member is arranged near an upper end of the substrate.

2. The etching apparatus of claim 1, wherein each of the first and second spray members comprises:
a transfer pipe extending in a first direction;
and a plurality of nozzles arranged on the transfer pipe.

3. The etching apparatus of claim 2, wherein a number of nozzles arranged on the second spray member is greater than a number of nozzles arranged on the first spray member.

4. The etching apparatus of claim 3, wherein the number of nozzles arranged on the second spray member is 1.2 to 3 times the number of nozzles arranged on the first spray member.

5. The etching apparatus of claim 2, wherein an outlet diameter of each nozzle arranged on the second spray member is larger than an outlet diameter of each nozzle arranged on the first spray member.

6. The etching apparatus of claim 5, wherein an outlet diameter of each nozzle arranged on the second spray member is 1.1 to 3 times an outlet diameter of each nozzle arranged on the first spray member.

7. The etching apparatus of claim 2, further comprising a distribution pipe connected and to supply an etching solution to each of the first and second spray members.

8. The etching apparatus of claim 7, wherein the etching apparatus comprises a plurality of first spray members and a plurality of second spray members, the distribution pipe being connected to the plurality of second spray members, the plurality of second spray members being arranged closer to the upper end of the substrate than the plurality of first spray members.

9. The etching apparatus of claim 2, further comprising a third spray member arranged between the second spray member and the first spray member and spraying a smaller amount of etching solution onto the substrate than the second spray member and spraying a greater amount of etching solution onto the substrate than the first spray member.

10. The etching apparatus of claim 9, wherein the third spray member comprises fewer nozzles than the second spray member and more nozzles than first spray member.

11. The etching apparatus of claim 9, further comprising:
a fourth spray member spraying a smaller amount of etching solution onto the substrate than the third spray member; and
a fifth spray member spraying a smaller amount of etching solution onto the substrate than the fourth spray member, wherein the fifth spray member sprays a larger amount of etching solution onto the substrate than the first spray member, the fourth spray member is arranged between the third spray member and the fifth spray member, and the fifth spray member is arranged between the fourth spray member and the first spray member.

12. A spray etching apparatus, comprising:
a support member arranged on a lower side of the substrate to support the substrate at an incline; and
a plurality of spray members arranged over an upper side of the substrate and extending in a first direction across the substrate and being spaced-apart from one another from a lower end to an upper end of the inclined substrate, wherein a one of the spray members arranged closest to the upper end of the inclined substrate to discharge an etching solution at a greater rate than a one of the spray members arranged closest to the lower end of the inclined substrate.

13. The spray etching apparatus of claim 12, wherein a discharge rate of etching solution of the spray members gets progressively larger in moving from the lower end to the upper end of the substrate.

14. The spray etching apparatus of claim 12, wherein the discharge rate of each spray member varies according to a spacing between adjoining nozzles on any given spray member.

15. The spray etching apparatus of claim 12, wherein the discharge rate of each spray member varies according to an inner diameter of nozzles arranged on any given spray member.
